(19) United States
(12) Patent Application Publication
(10) Pub. No.: US 2018/0198658 A1
(43) Pub. Date: Jul. 12, 2018

(54) Reference Signal in an OFDM System

(71) Applicant: Telefonaktiebolaget LM Ericsson (publ), Stockholm (SE)

(72) Inventors: Qiang Zhang, Täby (SE); Håkan Andersson, Linköping (SE); Mattias Frenne, Uppsala (SE); Johan Furuskog, Stockholm (SE); Niclas Wiberg, Linköping (SE)

(73) Assignee: Telefonaktiebolaget LM Ericsson (publ), Stockholm (SE)

(21) Appl. No.: 15/531,640

(22) PCT Filed: Apr. 6, 2017
(86) PCT No.: PCT/SE2017/050343

§ 371 Date: May 30, 2017

Related U.S. Application Data
(60) Provisional application No. 62/323,557, filed on Apr. 15, 2016.

(51) Int. Cl. H04L 27/26; H04L 5/00

(52) U.S. Cl. CPC H04L 27/2613; H04L 5/0048

(57) ABSTRACT

A radio node (e.g., a base station) (12) is configured to generate a reference signal (16) in an Orthogonal Frequency-Division Multiplexing (OFDM) system (10). The radio node (12) in this regard is configured to generate a reference signal (16) that comprises a sequence of reference symbols distributed respectively on spaced OFDM subcarriers (18) within a transmission bandwidth such that the sequence successively repeats an integer number n of times in the time domain over an OFDM symbol period (22). Adjacent ones of the spaced OFDM subcarriers (18) that do not straddle a center OFDM subcarrier have z intermediate OFDM subcarriers (20) therebetween, where z>0. By contrast, adjacent ones of the spaced OFDM subcarriers (18) that do straddle the center OFDM subcarrier have z+n intermediate OFDM subcarriers (20) therebetween, where n>1. The center OFDM subcarrier is at the center of the transmission bandwidth with no signal to be transmitted thereon.

### RELATED APPLICATIONS

This application claims priority from U.S. Provisional Patent Application Ser. No. 62/323,557, which was filed on 15 Apr. 2016 and is incorporated by reference herein in its entirety.

### TECHNICAL FIELD

The present disclosure generally relates to a reference signal in a wireless communication system, and particularly relates to generating and receiving a reference signal in an Orthogonal Frequency-Division Multiplexing, OFDM, system.

### BACKGROUND

With the emerging 5th Generation, 5G, technologies, the use of a large number of receive-antenna elements has gained increasing interest. The antenna signals can also come from several antenna polarizations. At the receiver, the antenna signals are first received in a Radio Unit, RU. The signals are then sampled and quantized in an Analog-to-Digital Converter, ADC. A transformation from time to frequency-domain is performed using a Fast Fourier Transform, FFT, or a Discrete Fourier Transform, DFT, after which the receiver processing is applied. An FFT is typically calculated for each antenna or subset of antennas, such that different users and channels in different sub-bands of the received signal can be extracted before further signal processing.

In order to increase received signal strength, a beamforming procedure can be employed in which several antenna signals are scaled, phase-shifted, and added before the receiver processing. One goal of beamforming is to combine received signals from several antennas so that more signal energy is received in specific spatial directions. Several beams can be formed in order to beamform towards different spatial directions. With two polarizations, the antenna signals from each polarization are typically beamformed separately. The same, or different, beamforming can be applied to the different polarizations.

In some beamforming receivers, beamforming is performed in the frequency-domain, i.e., after the FFT. After the FFT, the individual sub-carriers are extracted so that different physical channels and signals can be extracted. With digital beamforming in the frequency-domain, the antenna signals are first processed with an FFT and then beamformed. In this manner, different sub-carriers can be beamformed differently. This allows for different beamforming for different physical channels and signals. Also, if several user equipments, UEs, are multiplexed in frequency, then the signals for each UE can be processed with individual beamforming.

Alternatively, the beamforming can be done in the time domain. In this case, the beamforming is performed on a digital signal, i.e., after the analog-to-digital conversion, but before the FFT-conversion to the frequency-domain. Since the FFT is calculated after the beamforming, all sub-carriers are beamformed in the same spatial direction.

In another alternative of time-domain beamforming, the beamforming is performed before analog-to-digital conversion. Combinations of analog and digital beamforming, and time- and frequency-domain beamforming, are also possible.

With the advent of more advanced UEs with advanced antennas containing many antenna elements, the possibility of UE receive beamforming is a reality. In order for the UE to assess the quality of a particular receive-beam configuration, it needs to perform measurements on a known reference signal transmitted from the base station, also known as an Evolved Node B, eNB, in Long-Term Evolution, LTE. The reference signals for measurements are typically transmitted using a predefined, or configured, interval. Alternatively, the measurement signals may be scheduled to provide measuring opportunities for one or several designated UEs. The predefined variant is typically called Beam-Reference Signals, BRS, while the more dynamic variant is typically some type of Channel-State Information Reference Signals, CSI-RSs. The periodicity of these reference signals is a trade-off between providing more measurement opportunities and using time-frequency resources that could otherwise have been used for downlink data.

The receiving UE uses the reference signals to evaluate as many receive-beamforming configurations as possible to determine the best configuration. With analog beamforming, the number of configurations, or, equivalently, spatial receive directions, is limited by the number of analog beamformers available in the UE.

In 5G, the radio-access technology is based on Orthogonal Frequency-Division Multiplexing, OFDM. Hence, a transmission-time interval, TTI, typically called a subframe, consists of a number of OFDM-symbols. The whole subframe is scheduled at once, but each OFDM-symbol is generated separately from its frequency-domain representation of the signal to be transmitted using an Inverse FFT, IFFT. Each OFDM-symbol has a cyclic prefix prepended to the time-domain signal before it is transmitted over the air.

In 5G, a typical OFDM-symbol duration would be around 10-15 μs, with the cyclic prefix around 1 μs. Switching between different receive-beam configurations in the UE takes on the order of 0.1 μs. Hence, switching receive-beam configurations between OFDM-symbols is not an issue because the switch time is only a fraction of the cyclic prefix.

It is possible to take advantage of the short switching time of the receiver and introduce shorter OFDM-symbols, complete with cyclic prefixes, which are short enough to fit several short OFDM symbols within the OFDM-duration normally used in the 5G system. Each short OFDM-symbol could contain reference signals used to perform measurements. It would therefore be possible for the UE to perform measurements on these reference signals using different receive-beam configurations. For example, if n short reference signals, RS, are transmitted during one normal OFDM symbol period, the receiver could perform measurements to evaluate n receive-beam configurations. This solution would increase the number of measurement opportunities for the UE, and consequently, decrease the time it would take to evaluate all available receive-beam configurations.

There are some drawbacks to using shortened OFDM symbols to perform measurements. One drawback is that the measurement duration for each receive-beam configuration is much shorter compared to the regular OFDM-symbol duration. Thus, the amount of energy gathered at the receiver may not be sufficient to perform accurate measurements, which may result in a coverage problem. Also, if each short “mini-OFDM-symbol” has its own cyclic prefix of the same length as that of a normal OFDM symbol, the cyclic prefix overhead becomes very large, reducing the overall efficiency of the method. If, alternatively, each mini-OFDM-symbol has a correspondingly shorter cyclic prefix, the method becomes more sensitive to radio channels with large time dispersion, and the time synchronization becomes more challenging. The introduction of a mini-OFDM-symbol with its own cyclic prefix makes the transmitter implementation more complex, since it needs to support different OFDM-symbol lengths. Inter-subcarrier interference will also occur when receiving frequency-multiplexed OFDM-symbols with different lengths, where each symbol has a cyclic prefix. This interference can be reduced by introducing bandpass filters for each frequency interval of different OFDM-symbol lengths, a.k.a. filtered OFDM. However, these bandpass filters will introduce additional delay spread of the channel such that longer cyclic prefixes are needed. Additional guard bands will also reduce the spectral efficiency.

Note that the Background section of this document is provided to place embodiments of the present invention in technological and operational context, to assist those of skill in the art in understanding their scope and utility. Approaches descried in the Background section could be pursued, but are not necessarily approaches that have been previously conceived or pursued. Unless explicitly identified as such, no statement herein is admitted to be prior art merely by its inclusion in the Background section.

### SUMMARY

Embodiments herein include a method of generating a reference signal in an Orthogonal Frequency-Division Multiplexing, OFDM, system. The method comprises generating a reference signal that comprises a sequence of reference symbols distributed respectively on spaced OFDM subcarriers within a transmission bandwidth such that the sequence successively repeats an integer number n of times in the time domain over an OFDM symbol period, where n>1. Adjacent ones of the spaced OFDM subcarriers that do not straddle a center OFDM subcarrier have z intermediate OFDM subcarriers therebetween, where z>0. Adjacent ones of the spaced OFDM subcarriers that do straddle the center OFDM subcarrier have z+n intermediate OFDM subcarriers therebetween. The center OFDM subcarrier is at the center of the transmission bandwidth with no signal to be transmitted thereon.

In at least some embodiments, the above approach advantageously ensures each of the reference symbols' distribution in the frequency domain produces an integer number n of repetitions of the sequence in the time domain over the OFDM symbol period. This may be accomplished by for example ensuring that the reference symbols are distributed on subcarriers at certain frequencies, accounting for the effect that the center OFDM subcarrier will have on that distribution. With the reference signal comprising an integer number of repetitions of the sequence, measurements of the reference signal performed at different times are comparable. A wireless communication device may for instance measure the reference signal over an integer number of time intervals during which the same reference symbols are transmitted, and then compare those measurement results to one another without differences in reference symbols skewing those results. Where the wireless communication device uses different receive-beam configurations for performing the different measurements, the wireless communication device may effectively evaluate which receive-beam configuration is best based on the measurement results.

Regardless, the method in some embodiments further comprises transmitting the generated reference signal within the OFDM symbol period.

In some embodiments, the sequence comprises r reference symbols distributed respectively on r spaced OFDM subcarriers, where

$$r \leq \frac{N}{n} ,$$

and where N is a total number of subcarriers defined within the transmission bandwidth. Note that, in some embodiments where N is odd, the center OFDM subcarrier is in between a set of

$$\frac{N - 1}{2}$$

OFDM subcarriers that are lower in frequency within the transmission bandwidth and a set of

$$\frac{N - 1}{2}$$

OFDM subcarriers that are higher in frequency within the transmission bandwidth.

In any of these embodiments, z may be defined such that z=n−1. More generally, z may be defined such that z=mn+n−1, where m≥0.

In some embodiments, generating the reference signal comprises applying the reference symbols to modulators that respectively correspond to the spaced OFDM subcarriers.

In some embodiments, generating the reference signal comprises constructing a sequence of N−1 symbols in sequence positions that respectively map to N−1 OFDM subcarriers defined within the transmission bandwidth, excluding the center OFDM subcarrier to which no sequence position is mapped, where N is a total number of subcarriers defined within the transmission bandwidth.

In some embodiments, the sequence positions are indexed with an index k whose range crosses but does not include k=0. In this case, constructing the sequence may comprise constructing the sequence to include the reference symbols in sequence positions that have indices k where k modn=0.

In some embodiments, constructing the sequence may comprise constructing the sequence to include zero-valued symbols in sequence positions which respectively map to the intermediate OFDM subcarriers, excluding the center OFDM subcarrier.

In some embodiments, constructing the sequence may comprise constructing the sequence to include z+n−1 zero-valued symbols in sequence positions which map to the intermediate OFDM subcarriers between adjacent ones of the spaced OFDM subcarriers that do straddle the center OFDM subcarrier.

In some embodiments, constructing the sequence may comprise constructing the sequence to include z zero-valued symbols in sequence positions which map to the intermediate OFDM subcarriers between adjacent ones of the spaced OFDM subcarriers that do not straddle the center OFDM subcarrier.

In some embodiments, generating the reference signal comprises generating the reference signal according to:

$${s}_{l}^{( p )} ( t ) = {\sum }_{k = - ⌊ {N}_{RB}^{DL} {N}_{sc}^{RB} \text{/} 2 ⌋}^{- 1} {a}_{{k}^{( - ) , l}}^{( p )} \cdot {e}^{j 2 π k Δ f ( t - {N}_{CP , l} {T}_{s} )} + {\sum }_{k = 1}^{⌈ {N}_{RB}^{DL} {N}_{sc}^{RB} \text{/} 2 ⌉} {a}_{{k}^{( + ) , l}}^{( p )} \cdot {e}^{j 2 π k Δ f ( t - {N}_{CP , l} {T}_{s} )}$$

where sₗ^{(p)}(t) is the reference signal to be transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k+└N_{RB}^{DL}N_{sc}^{RB}/2┘ and k⁽⁺⁾=k+└N_{RB}^{DL}N_{sc}^{RB}/2┘−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{⁽⁺⁾}_{,l}^{(p)} is a value of resource element (k⁽⁺⁾,l) for antenna port p.

In some embodiments, generating the reference signal comprises constructing a sequence of N−z−1 symbols in sequence positions that respectively map to N−z−1 OFDM subcarriers defined within the transmission bandwidth, wherein no sequence position maps to the center OFDM subcarrier or z OFDM subcarriers adjacent to or surrounding the center OFDM subcarrier, where N is a total number of subcarriers defined within the transmission bandwidth.

In some of these embodiments, constructing the sequence may comprise constructing the sequence to include zero-valued symbols in sequence positions which respectively map to the intermediate OFDM subcarriers, excluding the center OFDM subcarrier and the z OFDM subcarriers adjacent to the center OFDM subcarrier.

In some embodiments, constructing the sequence may comprise constructing the sequence to include z zero-valued symbols in between each pair of adjacent reference symbols.

In some embodiments, the sequence positions are indexed with an index k whose range crosses but does not include k=0. In this case, constructing the sequence may comprise sequentially inserting the reference symbols in sequence positions in order of increasing or decreasing indices.

In some embodiments, such inserting starts with a first reference symbol which is inserted in a sequence position that has an index k where k mod n=0.

In some embodiments, generating the reference signal comprises generating the reference signal according to:

$${s}_{l}^{( p )} ( t ) = {\sum }_{k = - ⌊ {N}_{RB}^{DL} {N}_{sc}^{RB} \text{/} 2 ⌋}^{- 1} {a}_{{k}^{( - ) , l}}^{( p )} \cdot {e}^{j 2 π k Δ f ( t - {N}_{CP , l} {T}_{s} )} + {\sum }_{k = 1}^{⌈ {N}_{RB}^{DL} {N}_{sc}^{RB} \text{/} 2 ⌉ - z} {a}_{{k}^{( + ) , l}}^{( p )} \cdot {e}^{j 2 π ( k + z ) Δ f ( t - {N}_{CP , l} {T}_{s} )}$$

where sₗ^{(p)}(t) is the reference signal to be transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k+└N_{RB}^{DL}N_{sc}^{RB}/2┘ and k⁽⁺⁾=k+z+└N_{RB}^{DL}N_{sc}^{RB}/2┘−1, where k⁽⁺⁾≤N_{RB}^{DL}N_{sc}^{RB}−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{⁽⁺⁾}_{,l} is a value of resource element (k⁽⁺⁾,l) for antenna port p.

In other embodiments, such inserting starts with a first reference symbol which is inserted in a sequence position that has an index k where k mod n=x and where x≠0.

In some embodiments, generating the reference signal comprises generating the reference signal according to:

$${s}_{l}^{( p )} ( t ) = {\sum }_{k = - ⌊ {N}_{RB}^{DL} {N}_{sc}^{RB} \text{/} 2 ⌋ + x}^{- 1} {a}_{{k}^{( - ) , l}}^{( p )} \cdot {e}^{j 2 π ( k - x ) Δ f ( t - {N}_{CP , l} {T}_{s} )} + {\sum }_{k = 1 + x}^{⌈ {N}_{RB}^{DL} {N}_{sc}^{RB} \text{/} 2 ⌉ + x} {a}_{{k}^{( + ) , l}}^{( p )} \cdot {e}^{j 2 π ( k + z - x ) Δ f ( t - {N}_{CP , l} {T}_{s} )}$$

where sₗ^{(p)}(t) is the reference signal to be transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k−x+└N_{RB}^{DL}N_{sc}^{RB}/2┘ and k⁽⁺⁾=k−x+└N_{RB}^{DL}N_{sc}^{RB}/2┘−1, where k⁽⁺⁾≤N_{RB}^{DL}N_{sc}^{RB}−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{⁽⁺⁾}_{,l}^{(p)} is a value of resource element (k⁽⁺⁾,l) for antenna port p.

In any of these embodiments, the center OFDM subcarrier may be a direct current subcarrier at baseband.

Embodiments herein also include a method of performing measurements on a reference signal in an Orthogonal Frequency-Division Multiplexing, OFDM, system. The method comprises receiving, within an OFDM symbol period, a reference signal that comprises a sequence of reference symbols distributed respectively on spaced OFDM subcarriers within a transmission bandwidth such that the sequence successively repeats an integer number n of times in the time domain over the OFDM symbol period, where n>1. Adjacent ones of the spaced OFDM subcarriers that do not straddle a center OFDM subcarrier have z intermediate OFDM subcarriers therebetween, where z>0. Adjacent ones of the spaced OFDM subcarriers that do straddle the center OFDM subcarrier have z+n intermediate OFDM subcarriers therebetween. The center OFDM subcarrier is at the center of the transmission bandwidth with no signal to be transmitted thereon. The method also comprises performing one or more measurements of the reference signal received within the OFDM symbol period.

In some embodiments, the method comprises evaluating multiple different receive-beam configurations based on the one or more measurements of the reference signal.

In some embodiments, the performing comprises performing multiple different measurements using different sets of time-domain samples from the reference signal that respectively represent different repetitions of the sequence over the OFDM symbol period.

In some embodiments, the method further comprises generating evaluation metrics for different candidate receive-beam configurations based on said different measurements, and selecting one of the candidate receive-beam configurations based on the evaluation metrics.

In some embodiments, the method further comprises dynamically switching between different receive-beam configurations for receiving different repetitions of the sequence, based on said one or more measurements.

In some embodiments, the sequence comprises r reference symbols distributed respectively on r spaced OFDM subcarriers, and wherein

$$r \leq \frac{N}{n} ,$$

where N is a total number of subcarriers defined within the transmission bandwidth. In this case, where N is odd, the center OFDM subcarrier may be in between a set of

$$\frac{N - 1}{2}$$

OFDM subcarriers that are lower in frequency within the transmission bandwidth and a set of

$$\frac{N - 1}{2}$$

OFDM subcarriers that are higher in frequency within the transmission bandwidth.

In some embodiments, z=n−1. More generally, z may be defined such that z=mn+n−1, where m≥0.

In some embodiments, the receiving comprises receiving the reference signal based on a sequence of N−1 symbols having been constructed in sequence positions that are respectively mapped to N−1 OFDM subcarriers defined within the transmission bandwidth, excluding the center OFDM subcarrier to which no sequence position is mapped, where N is a total number of subcarriers defined within the transmission bandwidth.

In some of these embodiments, the sequence positions may be indexed with an index k whose range crosses but does not include k=0, and the receiving may comprise receiving the reference signal based on the sequence having been constructed to include the reference symbols in sequence positions that have indices k where k mod n=0.

In some embodiments, the receiving comprises receiving the reference signal based on the sequence having been constructed to include zero-valued symbols in sequence positions which respectively map to the intermediate OFDM subcarriers, excluding the center OFDM subcarrier.

In some embodiments, the receiving comprises receiving the reference signal based on the sequence having been constructed to include z+n−1 zero-valued symbols in sequence positions which map to the intermediate OFDM subcarriers between adjacent ones of the spaced OFDM subcarriers that do straddle the center OFDM subcarrier.

In some embodiments, the receiving comprises receiving the reference signal based on the sequence having been constructed to include z zero-valued symbols in sequence positions which map to the intermediate OFDM subcarriers between adjacent ones of the spaced OFDM subcarriers that do not straddle the center OFDM subcarrier.

In some embodiments, the receiving comprises receiving the reference signal based on the reference signal having been generated according to:

$${s}_{l}^{( p )} ( t ) = {\sum }_{k = - ⌊ {N}_{RB}^{DL} {N}_{sc}^{RB} \text{/} 2 ⌋}^{- 1} {a}_{{k}^{( - )} , l}^{( p )} \cdot {e}^{j 2 π k Δ f ( t - {N}_{CP , l} {T}_{s} )} + {\sum }_{k = 1}^{⌈ {N}_{RB}^{DL} {N}_{sc}^{RB} \text{/} 2 ⌉} {a}_{{k}^{( + ) , l}}^{( p )} \cdot {e}^{j 2 π k Δ f ( t - {N}_{CP , l} {T}_{s} )}$$

where sₗ^{(p)}(t) is the reference signal transmitted on antenna port p in OFDM symbol l in a downlink slot, where N_{RB}^{DL} is a downlink bandwidth configuration expressed in multiples of N_{sc}^{RB} where N_{sc}^{RB} is a resource block size in the frequency domain expressed as a number of subcarriers, where k⁽⁻⁾=k+└N_{RB}^{DL}N_{sc}^{RB}/2┘ and k⁽⁺⁾=k+└N_{RB}^{DL}N_{sc}^{RB}/2┘−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{⁽⁺⁾}_{,l}^{(p)} is a value of resource element (k⁽⁺⁾,l) for antenna port p.

In some embodiments, the receiving comprises receiving the reference signal based on a sequence of N−z−1 symbols having been constructed in sequence positions that respectively map to N−z−1 OFDM subcarriers defined within the transmission bandwidth, wherein no sequence position maps to the center OFDM subcarrier or z OFDM subcarriers adjacent to or surrounding the center OFDM subcarrier, where N is a total number of subcarriers defined within the transmission bandwidth.

In some embodiments, the receiving comprises receiving the reference signal based on the sequence having been constructed to include zero-valued symbols in sequence positions which respectively map to the intermediate OFDM subcarriers, excluding the center OFDM subcarrier and the z OFDM subcarriers adjacent to the center OFDM subcarrier.

In some embodiments, the receiving comprises receiving the reference signal based on the sequence having been constructed to include z zero-valued symbols in between each pair of adjacent reference symbols.

In some embodiments, the sequence positions are indexed with an index k whose range crosses but does not include k=0. In this case, the receiving may comprise receiving the reference signal based on the sequence having been constructed by sequentially inserting the reference symbols in sequence positions in order of increasing or decreasing indices.

In some embodiments, the receiving comprises receiving the reference signal based on said inserting having started with a first reference symbol which is inserted in a sequence position that has an index k where k mod n=0.

In some embodiments, the receiving comprises receiving the reference signal based on the reference signal having been generated according to:

$${s}_{l}^{( p )} ( t ) = {\sum }_{k = - ⌊ {N}_{RB}^{DL} {N}_{sc}^{RB} \text{/} 2 ⌋}^{- 1} {a}_{{k}^{( - )} , l}^{( p )} \cdot {e}^{j 2 π k Δ f ( t - {N}_{CP , l} {T}_{s} )} + {\sum }_{k = 1}^{⌈ {N}_{RB}^{DL} {N}_{sc}^{RB} \text{/} 2 ⌉ - z} {a}_{{k}^{( + ) , l}}^{( p )} \cdot {e}^{j 2 π ( k + z ) Δ f ( t - {N}_{CP , l} {T}_{s} )}$$

where sₗ^{(p)}(t) is the reference signal transmitted on antenna port p in OFDM symbol l in a downlink slot, where N_{RB}^{DL} is a downlink bandwidth configuration expressed in multiples of N_{sc}^{RB} where N_{sc}^{RB} is a resource block size in the frequency domain expressed as a number of subcarriers, where k⁽⁻⁾=k+└N_{RB}^{DL}N_{sc}^{RB}/2┘ and k⁽⁺⁾=k+z+└N_{RB}^{DL}N_{sc}^{RB}/2┘−1, where k⁽⁺≤N_{RB}^{DL}N_{sc}^{RB}−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{^{(−)}}_{,l}^{(p)} is a value of resource element (k⁽⁺⁾,l) for antenna port p.

In some embodiments, the receiving comprises receiving the reference signal based on said inserting having started with a first reference symbol which is inserted in a sequence position that has an index k where k mod n=x and where x≠0.

In some embodiments, the receiving comprises receiving the reference signal based on the reference signal having been generated according to:

$${s}_{l}^{( p )} ( t ) = {\sum }_{k = - ⌊ {N}_{RB}^{DL} {N}_{sc}^{RB} \text{/} 2 ⌋ + x}^{- 1} {a}_{{k}^{( - ) , l}}^{( p )} \cdot {e}^{j 2 π ( k - x ) Δ f ( t - {N}_{CP , l} {T}_{s} )} + {\sum }_{k = 1 + x}^{⌈ {N}_{RB}^{DL} {N}_{sc}^{RB} \text{/} 2 ⌉ + x} {a}_{{k}^{( + ) , l}}^{( p )} \cdot {e}^{j 2 π ( k + z - x ) Δ f ( t - {N}_{CP , l} {T}_{s} )}$$

where sₗ^{(p)}(t) is the reference signal transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k−x+└N_{RB}^{DL}N_{sc}^{RB}/2┘ and k⁽⁺⁾=k−x+└N_{RB}^{DL}N_{sc}^{RB}/2┘−1, where k⁽⁺⁾≤N_{RB}^{DL}N_{sc}^{RB}−1, where N_{CP,l} is a downlink cyclic prefix length for OFDM symbol l in a slot, where Tₛ is a basic time unit, where Δf is a subcarrier spacing, where aₖ_{^{(−)}}_{,l} is a value of resource element (k⁽⁻⁾,l) for antenna port p, and where aₖ_{⁽⁺⁾}_{,l}^{(p)} is a value of resource element (k⁽⁺⁾,l) for antenna port p.

In any of these embodiments, the center OFDM subcarrier may be a direct current subcarrier at baseband.

Embodiments herein also include corresponding radio nodes, computer programs, and carriers thereof include computer program products.

Note that the summary section presents a simplified summary of the disclosure in order to provide a basic understanding to those of skill in the art. This summary is not an extensive overview of the disclosure and is not intended to identify key/critical elements of embodiments herein or to delineate the scope of the invention. The sole purpose of this summary is to present some concepts disclosed herein in a simplified form as a prelude to the more detailed description that is presented later.

### DETAILED DESCRIPTION

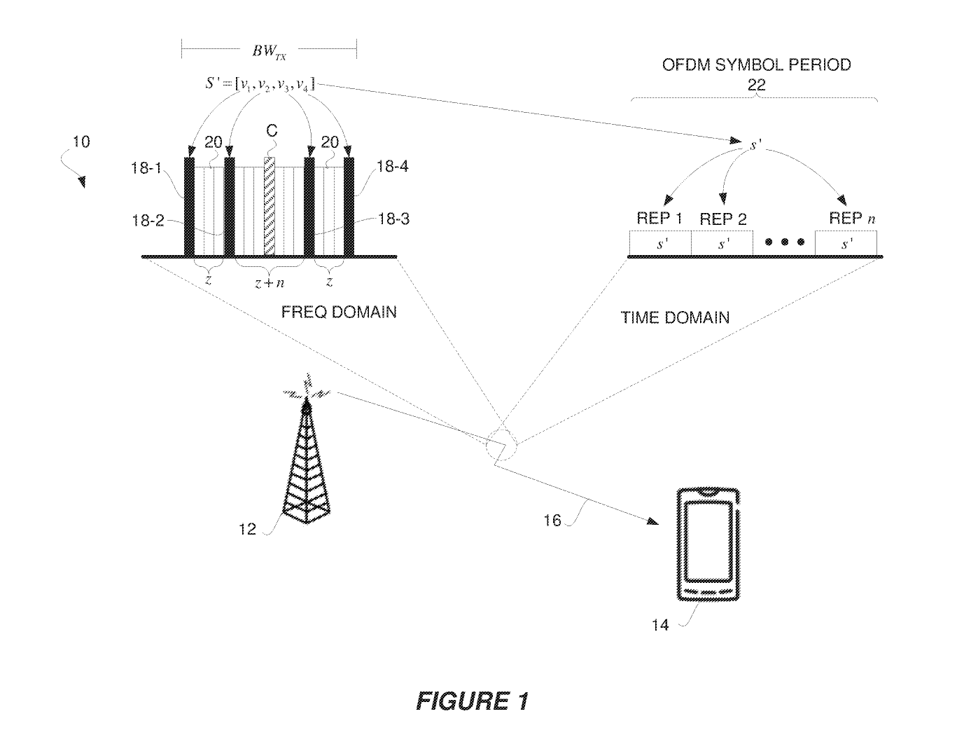

FIG. 1 shows an Orthogonal Frequency-Division Multiplexing, OFDM, system 10 as a wireless communication system, e.g., a 5G system, that includes radio nodes which each transmit and/or receive OFDM radio signals. These radio nodes are shown in FIG. 1 as being a base station 12 and a wireless communication device 14, e.g., a user equipment.

The base station 12 is configured to generate a reference signal 16 for transmission to the wireless communication device 14. This reference signal 16 may be for example a channel-state information reference signal, CSI-RS, a beam-reference signal, BRS, or any signal that is known a priori to the wireless communication device 14. Regardless, the base station 12 generates a reference signal 16 that comprises a sequence of reference symbols. FIG. 1 shows this sequence in the frequency domain as being a sequence S′ of four reference symbols v₁, v₂, v₃, v₄; that is, S′=[v₁, v₂, v₃, v₄].

These reference symbols v₁, v₂, v₃, v₄ are distributed respectively on spaced OFDM subcarriers 18 within a transmission bandwidth BW_{TX}, shown in FIG. 1 as subcarriers 18-1, 18-2, 18-3, and 18-4. The OFDM subcarriers 18 are spaced in the sense that they are separated from one another by one or more intermediate subcarriers 20. The base station 18 distributes the reference symbols v₁, v₂, v₃, v₄ on these spaced OFDM subcarriers 18 in such a way that the sequence of reference symbols successively repeats an integer number n of times in the time domain over an OFDM symbol period 22, where n>1. That the number of repetitions of the sequence is an integer may reflect that the sequence repeats exactly n times within the OFDM symbol period, i.e., there is no partial repetition of the sequence within the OFDM symbol period. FIG. 1 for example shows the sequence in the time domain as being a sequence s′ that repeats an integer number n of times over the OFDM symbol period 22, e.g., such that the reference signal 16 in the time domain is s=[s₁′, s₂′, . . . sₙ′]. This replication of the sequence in the time domain is accomplished by the base station's distribution of the reference symbols in the frequency domain; that is, diluting the subcarriers 18 on which the sequence of reference symbols are placed with intermediate subcarriers duplicates the sequence in the time domain.

Notably, the base station 12 distributes the reference symbols v₁, v₂, v₃, v₄ in the frequency domain in order to account for a center OFDM subcarrier C that is at the center of the transmission bandwidth BW_{TX}, with no signal to be transmitted thereon. This center OFDM subcarrier C may be at the center of the transmission bandwidth in the sense that the bandwidth extends approximately equally on each side of the center subcarrier C in the frequency domain. For example, where N is the total number of subcarriers defined within the transmission bandwidth BW_{TX}, the center OFDM subcarrier C may be between a set of

$$\frac{N - 1}{2}$$

OFDM subcarriers that are lower in frequency within the transmission bandwidth BW_{TX} and a set of

$$\frac{N - 1}{2}$$

OFDM subcarriers that are higher in frequency within the transmission bandwidth BW_{TX}, at least if N is odd. The center OFDM subcarrier C may be a direct current, DC, subcarrier at baseband, for example. In any event, the center OFDM subcarrier C is unused for transmission, e.g., because it is subject to disproportionately high interference due to local-oscillator leakage.

To account for this center OFDM subcarrier C, the base station 12 distributes the reference symbols v₁, v₂, v₃, v₄ on the spaced OFDM subcarriers 18 such that adjacent ones of the spaced OFDM subcarriers 18 that do not straddle the center OFDM subcarrier C have z intermediate OFDM subcarriers therebetween, and adjacent ones of the spaced OFDM subcarriers that do straddle the center OFDM subcarrier have z+n intermediate OFDM subcarriers therebetween, where z>0. That is, adjacent ones of the spaced OFDM subcarriers 18 that do straddle the center OFDM subcarrier C have n more intermediate OFDM subcarriers therebetween than adjacent ones of the spaced OFDM subcarriers 18 that do not straddle the center OFDM subcarrier C. Note that a pair of adjacent spaced OFDM subcarriers straddles the center OFDM subcarrier C if those subcarriers are positioned on opposite sides of the center OFDM subcarrier C. If on the other hand, those subcarriers are positioned on the same side of the center OFDM subcarrier C, that pair of adjacent spaced OFDM subcarriers does not straddle the center OFDM subcarrier C.

As shown in FIG. 1, for example, the spaced OFDM subcarriers 18-1 and 18-2 are adjacent in the sense that they appear adjacent to one another in an ordering of spaced OFDM subcarriers alone, ignoring intermediate subcarriers. This pair of adjacent spaced OFDM subcarriers 18-1, 18-2 does not straddle the center OFDM subcarrier C, because that center subcarrier C is not positioned in between those spaced OFDM subcarrier 18-1, 18-2 in the frequency domain, i.e., the center OFDM subcarrier C is not one of the intermediate OFDM subcarrier(s) lying between the spaced OFDM subcarriers 18-1 and 18-2. Accordingly, the pair of adjacent spaced OFDM subcarriers 18-1 and 18-2 has z intermediate subcarriers therebetween. The same can be said for the spaced OFDM subcarriers 18-3 and 18-4, which are adjacent to one another and do not straddle the center OFDM subcarrier C.

By contrast, the spaced OFDM subcarriers 18-2 and 18-3 are adjacent but they do straddle the center OFDM subcarrier C. That is, the center OFDM subcarrier C lies between those spaced OFDM subcarriers 18-2 and 18-3 in the frequency domain and is therefore one of the intermediate subcarriers 20 between them. Accordingly, the pair of adjacent spaced OFDM subcarriers 18-2 and 18-3 has z+n intermediate OFDM subcarriers therebetween, including the center OFDM subcarrier C. Note of course that FIG. 1 illustrates just one example where z=3 and n=4.

In at least some embodiments, the above approach advantageously ensures each of the reference symbols' distribution in the frequency domain produces an integer number n of repetitions of the sequence in the time domain over the OFDM symbol period 22. This may be accomplished by for example ensuring that the reference symbols are distributed on subcarriers at certain frequencies, accounting for the effect that the center OFDM subcarrier C will have on that distribution. With the reference signal 16 comprising an integer number of repetitions of the sequence, measurements of the reference signal 16 performed at different times are comparable. The wireless communication device 14 may for instance measure the reference signal 16 over an integer number of time intervals during which the same reference symbols are transmitted, and then compare those measurement results to one another without differences in reference symbols skewing those results. Where the wireless communication device 14 uses different receive-beam configurations for performing the different measurements, the wireless communication device 14 may effectively evaluate which receive-beam configuration is best based on the measurement results.

Note that the number of reference symbols and the number of spaced OFDM symbols to which those reference symbols are distributed may in some embodiments be related to or otherwise associated with the integer number n of times the sequence is repeated and/or the number N of subcarriers defined within the transmission bandwidth BW_{TX}. In one or more embodiments, for example, the sequence comprises r reference symbols distributed respectively on r spaced OFDM subcarriers, where

$$r = \frac{N}{n} .$$

More generally in other embodiments, though r may be defined such that

$$r \leq \frac{N}{n} .$$

Moreover, the number z of intermediate subcarriers between adjacent spaced OFDM subcarriers 18 that do not straddle the center OFDM subcarrier, i.e., non-straddling subcarriers, may similarly be related to or otherwise associated with the integer number n of times the sequence is repeated. In some embodiments, for example, the number z of intermediate subcarriers between non-straddling subcarriers is defined such that z=n−1. In this case, therefore, the number z+n of intermediate subcarriers between straddling subcarriers is defined such that z+n=(n−1)+n=2n−1. More generally, though, the number z of intermediate subcarriers between non-straddling subcarriers may defined such that z=mn+n−1, where m≥0, with m=0 thereby reducing to the specific case of z=n−1. And the number z+n of intermediate subcarriers between straddling subcarriers may therefore more generally be defined such that z+n=mn+(n−1)+n=mn+2n−1.

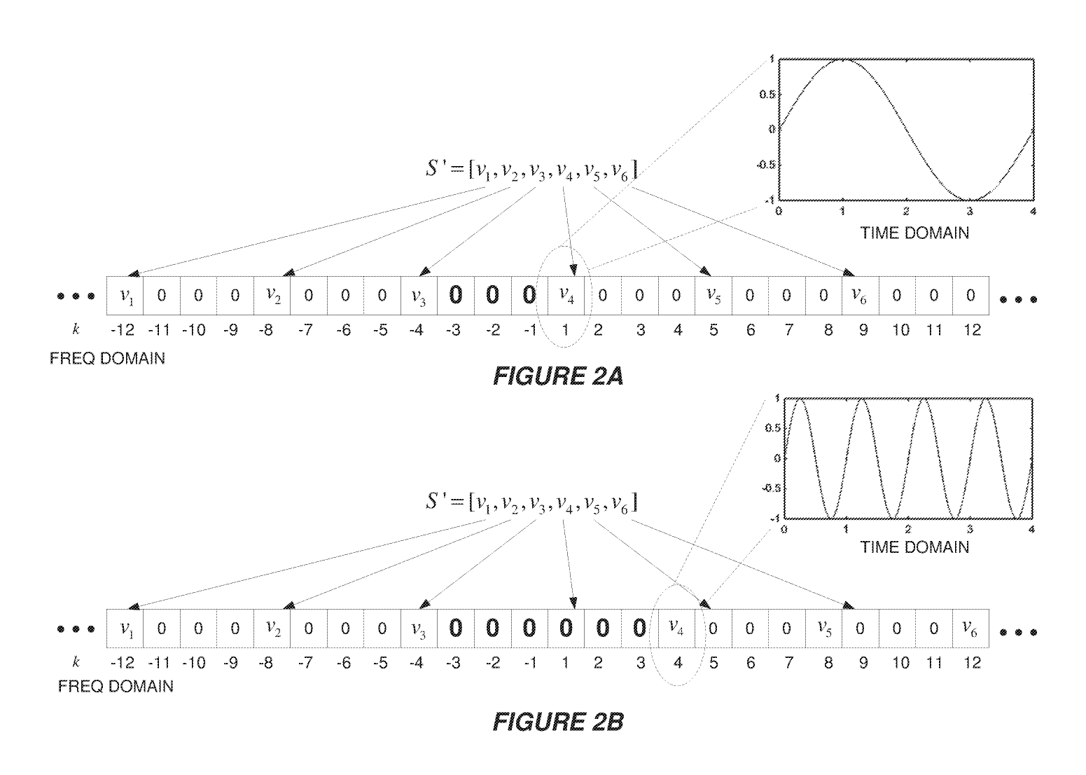

FIGS. 2A-2B illustrate one example in this regard where z=n−1=3 and where generation of the reference signal is performed in the frequency domain by constructing an overall sequence of N−1 symbols in sequence positions that respectively map to N−1 OFDM subcarriers defined within the transmission bandwidth, excluding the center OFDM subcarrier to which no sequence position is mapped. As shown in FIGS. 2A-2B, for instance, the sequence positions are indexed with an index k whose range crosses but does not include k=0. A symbol in sequence position with an index k is mapped to a corresponding OFDM subcarrier with an index k in the transmission bandwidth. Because no sequence position has an index k=0, no sequence position maps to the center OFDM subcarrier C which has an index k=0.

FIG. 2A shows an approach to distributing the reference symbols in the frequency domain that, in some cases, proves problematic in the sense that not all reference symbols produce n=4 repetitions in the time domain within an OFDM symbol period. In more detail, FIG. 2A shows an approach where the sequence of reference symbols are inserted into an overall sequence, at sequence positions which map to certain spaced OFDM subcarriers, e.g., starting with mapping v₁ to k=−12. Zero-valued symbols are inserted into other sequence positions which respectively map to intermediate OFDM subcarriers. In particular, the overall sequence is constructed to include z=n−1=3 zero-valued symbols between each pair of adjacent reference symbols, even v₃ and v₄ that map to subcarriers straddling the center subcarrier. Although v₁, v₂, and v₃ are placed in the frequency domain in such a way so as to produce an integer number n of repetitions of the sequence in the time domain, v₄, v₅, and v₆ are not placed in that way due to the index k skipping over k=0. As shown in FIG. 2A, for example, v₄ only produces a single “repetition” of the sequence in the time domain within the OFDM symbol period. This means for example that measurement results of the reference signal taken at different times are not comparable.

FIG. 2B by contrast shows an approach to distributing the reference symbols in the frequency domain such that all reference symbols produce n=4 repetitions in the time domain within an OFDM symbol period. Rather than mapping z=n−1=3 zero-valued symbols between each pair of adjacent reference symbols, FIG. 2B's approach maps a different number of zero-valued symbols between the pair of adjacent reference symbols that map to spaced subcarriers straddling the center subcarrier; namely z+n−1=(n−1)+n−1=2n−2=6. That is, in this example, the base station 12 constructs the overall sequence to include z zero-valued symbols in sequence positions which map to the intermediate OFDM subcarriers 20 between adjacent ones of the spaced OFDM subcarriers 18 that do not straddle the center OFDM subcarrier C, but constructs the overall sequence to include z+n−1 zero-valued symbols in sequence positions which map to the intermediate OFDM subcarriers 20 between adjacent ones of the spaced OFDM subcarriers 18 that do straddle the center OFDM subcarrier C. In some embodiments, for example, the base station 12 does so by simply constructing the overall sequence to include the reference symbols in sequence positions that have indices k where k mod n=0,e.g., starting with mapping v₁ to k=−12. Because there is no k=0 index, this effectively maps z=n−1=3 extra zero-valued symbols from k=1 to k=3 in this example. In any event, constructing the sequence in this way produces z=n−1=3 intermediate subcarriers 20 between adjacent spaced subcarriers 18 that do not straddle the center subcarrier C, and z+n=(n−1)+n=2n−1=7 intermediate subcarriers 20 between adjacent spaced subcarriers 18 that do straddle the center subcarrier C.

As shown, this approach of reference symbol distribution means that v₄ successfully produces n=4 repetitions of the sequence in the time domain within the OFDM symbol period. The same can be said for v₅ and v₆. As a result, measurement results of the reference signal taken at different times are comparable.

In some embodiments, the above approaches assume that the base station 12 generates the reference signal according to:

$${s}_{l}^{( p )} ( t ) = {\sum }_{k = - ⌊ {N}_{RB}^{DL} {N}_{sc}^{RB} \text{/} 2 ⌋}^{- 1} {a}_{{k}^{( - )} , l}^{( p )} \cdot {e}^{j 2 π k Δ f ( t - {N}_{CP , l} {T}_{s} )} + {\sum }_{k = 1}^{⌈ {N}_{RB}^{DL} {N}_{sc}^{RB} \text{/} 2 ⌉} {a}_{{k}^{( + ) , l}}^{( p )} \cdot {e}^{j 2 π k Δ f ( t - {N}_{CP , l} {T}_{s} )}$$

where sₗ^{(p)}(t) is the reference signal to be transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k+└N_{RB}^{DL}N_{sc}^{RB}/2┘ and k⁽⁺⁾=k+└N_{RB}^{DL}N_{sc}^{RB}/2┘−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{⁽⁺⁾}_{,l}^{(p)} is a value of resource element (k⁽⁺⁾,l) for antenna port p. See, e.g., 3GPP TS 36.211 v13.1.0, section 6.12. Notice here that a symbol aₖ_{⁽⁺⁾}_{,l}^{(p)} in a sequence position with an index k is mapped to a corresponding OFDM subcarrier (e^{j2πkΔf(t-N}^{_{CP,l}}^{T}^{ₛ}⁾) with an index k, with the summation terms skipping k=0 for the center OFDM subcarrier C.

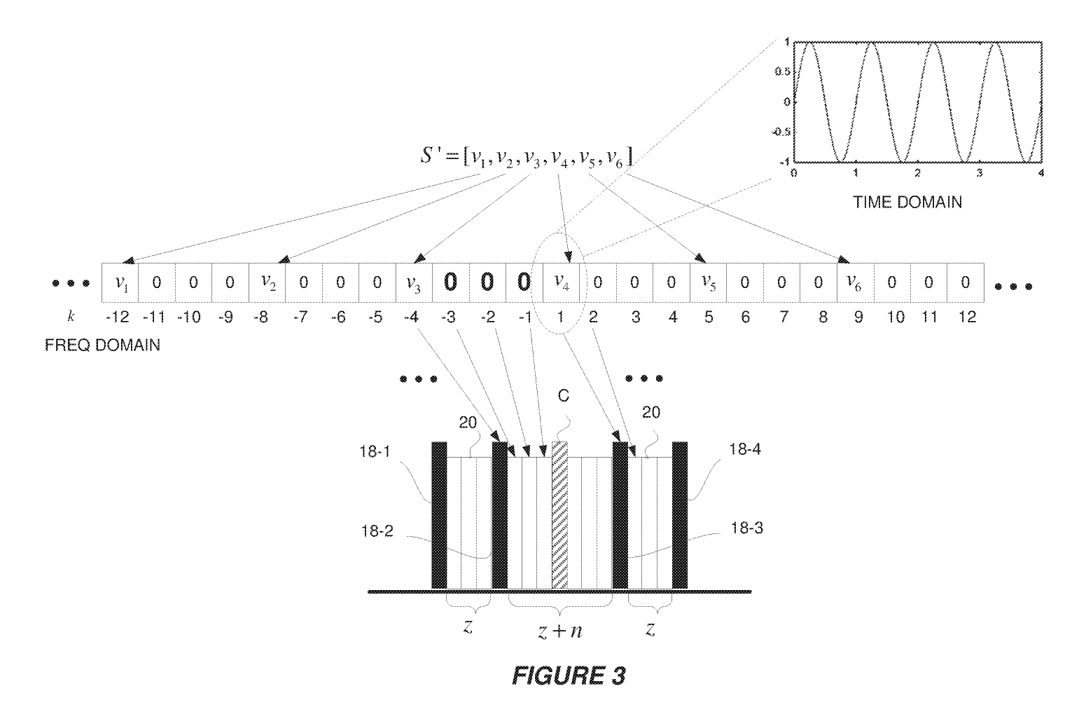

FIG. 3 illustrates alternative embodiments, however, where no sequence position maps to the center OFDM subcarrier or to z OFDM subcarriers adjacent to or surrounding the center OFDM subcarrier C. Here, the base station 12 generates the reference signal in the frequency domain by constructing an overall sequence of N−z−1 symbols in sequence positions that respectively map to N−z−1 OFDM subcarriers defined within the transmission bandwidth. Notably, the base station 12 constructs the overall sequence to include zero-valued symbols in sequence positions which respectively map to the intermediate OFDM subcarriers, excluding the center OFDM subcarrier and z=n−1=3 OFDM subcarriers adjacent to the center OFDM subcarrier.

As shown, for example, there is no sequence position which maps to the center subcarrier C; nor is there any sequence position which maps to the z=n−1=3 OFDM subcarriers immediately positioned to the right of the center subcarrier C, although any z=n−1=3 subcarriers that are adjacent to or surrounding the center subcarrier C could have been used instead. Because of this subcarrier mapping modification, the embodiment shown in FIG. 3 still constructs the overall sequence to include z=n−1=3 zero-valued symbols in between each pair of adjacent reference symbols, while still achieving the desired z=n−1=3 intermediate subcarriers 20 between adjacent spaced subcarriers 18 that do not straddle the center subcarrier C and z+n=(n−1)+n=2n−1=7 intermediate subcarriers 20 between adjacent spaced subcarriers 18 that do straddle the center subcarrier C.

Therefore, this alternative approach of reference symbol distribution also means that v₄ successfully produces n=4 repetitions of the sequence in the time domain within the OFDM symbol period. The same can be said for v₅ and v₆. As a result, measurement results of the reference signal taken at different times are comparable.

In some embodiments implementing the approach in FIG. 3, the base station 12 generates the reference signal according to:

$${s}_{l}^{( p )} ( t ) = {\sum }_{k = - ⌊ {N}_{RB}^{DL} {N}_{sc}^{RB} \text{/} 2 ⌋}^{- 1} {a}_{{k}^{( - )} , l}^{( p )} \cdot {e}^{j 2 π k Δ f ( t - {N}_{CP , l} {T}_{s} )} + {\sum }_{k = 1}^{⌈ {N}_{RB}^{DL} {N}_{sc}^{RB} \text{/} 2 ⌉ - z} {a}_{{k}^{( + ) , l}}^{( p )} \cdot {e}^{j 2 π ( k + z ) Δ f ( t - {N}_{CP , l} {T}_{s} )}$$

where sₗ^{(p)}(t) is the reference signal to be transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k+└N_{RB}^{DL}N_{sc}^{RB}/2┘ and k⁽⁺⁾=k+z+└N_{RB}^{DL}N_{sc}^{RB}/2┘−1, where k⁽⁺⁾≤N_{RB}^{DL}N_{sc}^{RB}−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{⁽⁺⁾}_{,l}^{(p)} is a value of resource element (k⁽⁺⁾,l) for antenna port p. Notice here that a symbol aₖ_{⁽⁺⁾}_{,l}^{(p)} in a sequence position with an index k>0 is mapped to a corresponding OFDM subcarrier (e^{j2π(k+z)Δf(t-N}^{_{CP,l}}^{T}^{ₛ}⁾) with an index k+z, with the summation terms skipping k=0 for the center OFDM subcarrier C and 0<k<z for z adjacent subcarriers to the immediate right of the center OFDM subcarrier C. Again, modifications for adjacent subcarriers to the immediate left of the center OFDM subcarrier C are possible as well as some combination of left and right adjacent subcarriers.

Note that the example of FIG. 3 illustrated an embodiment where the base station 12 constructs the overall sequence by sequentially inserting the reference symbols in sequence positions in order of increasing or decreasing indices k, starting with a first reference symbol, e.g., v₁, which is inserted in a sequence position that has an index k where k mod n=0,e.g., e.g., −12 mod 4=0 in this example for v₁. However, other approaches to starting this sequential insertion are envisioned herein. In some embodiments, for example, the base station 12 starts insertion with a first reference symbol, e.g., v₁, which is inserted in a sequence position that has an index k where k mod n=x and where x≠0.

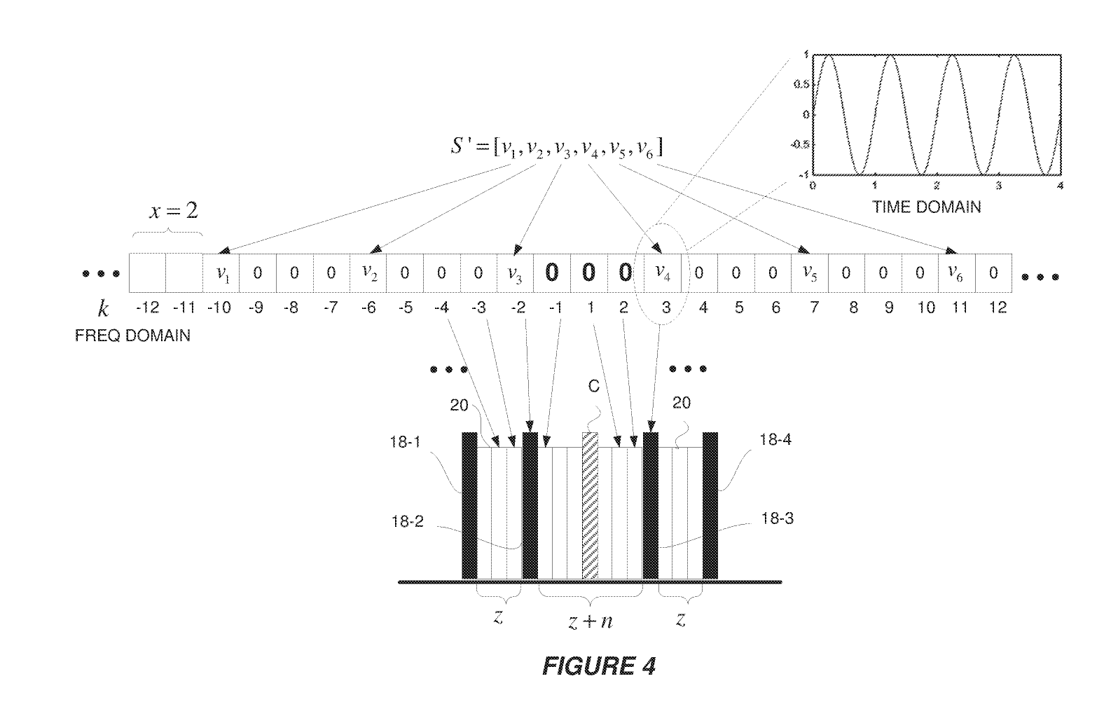

FIG. 4 illustrates one example where x=2 in this regard. Indeed, as shown the base station 12 starts inserting the first reference symbol v₁ in sequence position −10, rather than position −12 as in FIG. 3. This sequence position k=−10 means that −10 mod 4=x=2 in this example. As shown, though, this means that the base station 12 subcarrier mapping is appropriately adjusted such that no sequence position maps to the center subcarrier C, and no sequence position maps to z=n−1=3 OFDM subcarriers surrounding the center subcarrier C (here shown as two subcarriers to the left and one subcarrier to the right of the center subcarrier C).

In some embodiments implementing the approach in FIG. 4, the base station 12 generates the reference signal according to:

$${s}_{l}^{( p )} ( t ) = {\sum }_{k = - ⌊ {N}_{RB}^{DL} {N}_{sc}^{RB} \text{/} 2 ⌋ + x}^{- 1} {a}_{{k}^{( - ) , l}}^{( p )} \cdot {e}^{j 2 π ( k - x ) Δ f ( t - {N}_{CP , l} {T}_{s} )} + {\sum }_{k = 1 + x}^{⌈ {N}_{RB}^{DL} {N}_{sc}^{RB} \text{/} 2 ⌉ + x} {a}_{{k}^{( + ) , l}}^{( p )} \cdot {e}^{j 2 π ( k + z - x ) Δ f ( t - {N}_{CP , l} {T}_{s} )}$$

where sₗ^{(p)}(t) is the reference signal to be transmitted on antenna port p in OFDM symbol l in a downlink slot, where N_{RB}^{DL} is a downlink bandwidth configuration expressed in multiples of N_{sc}^{RB}, where N_{sc}^{RB} is a resource block size in the frequency domain expressed as a number of subcarriers, where k⁽⁻⁾=k−x+└N_{RB}^{DL}N_{sc}^{RB}/2┘ and k⁽⁺⁾=k−x+└N_{RB}^{DL}N_{sc}^{RB}/2┘−1, where k⁽⁺⁾≤N_{RB}^{DL}N_{sc}^{RB}−1, where N_{CP,l} is a downlink cyclic prefix length for OFDM symbol l in a slot, where Tₛ is a basic time unit, where Δf is a subcarrier spacing, where aₖ_{^{(−)}}_{,l}^{(p)} is a value of resource element (k⁽⁻⁾,l) for antenna port p, and where aₖ_{^{(−)}}_{,l}^{(p)} is a value of resource element (k⁽⁺⁾,l) for antenna port p. Notice here that a symbol aₖ_{^{(−)}}_{,l}^{(p)} in a sequence position with k<0 is mapped to a corresponding OFDM subcarrier (e^{j2π(k-x)Δf(t-N}^{_{CP,l}}^{T}^{ₛ}⁾) with an index k−z. And a symbol aₖ_{⁽⁺⁾}_{,l}^{(p)} in a sequence position with an index k>0 is mapped to a corresponding OFDM subcarrier (e^{j2π(k+-x)Δf(t-N}^{_{CP,l}}^{T}^{ₛ}⁾) with an index k+z−x.

In at least some embodiments, the wireless communication device 14 or other radio node correspondingly receives the reference signal 18 generated as described above. The device 14 may for instance perform one or more measurements of this reference signal 18 received within the OFDM symbol period 22.

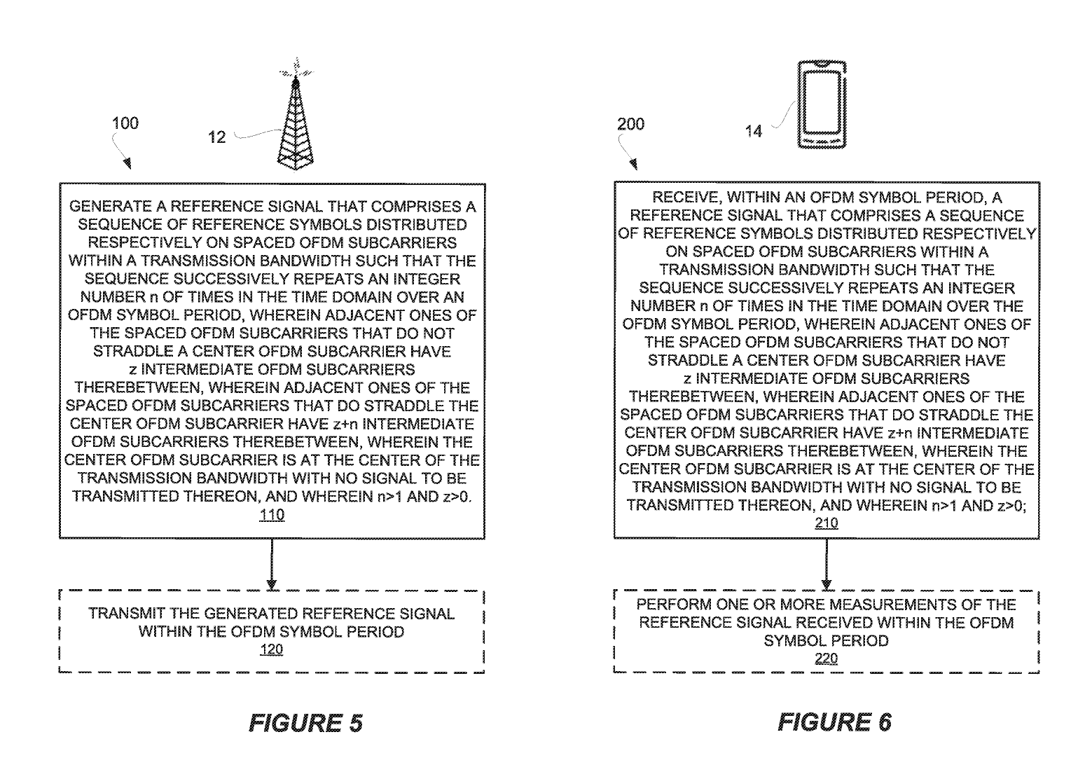

FIGS. 5 and 6 accordingly illustrate methods respectively performed according to one or more embodiments herein. FIG. 5 in this regard shows a method 100, e.g., performed by base station 12 or some other radio node, for generating a reference signal in an Orthogonal Frequency-Division Multiplexing, OFDM, system. The method 100 comprising generating a reference signal 16 that comprises a sequence of reference symbols distributed respectively on spaced OFDM subcarriers 18 within a transmission bandwidth such that the sequence successively repeats an integer number n of times in the time domain over an OFDM symbol period 22, Block 110. Adjacent ones of the spaced OFDM subcarriers 18 that do not straddle a center OFDM subcarrier C have z intermediate OFDM subcarriers 20 therebetween. Adjacent ones of the spaced OFDM subcarriers 18 that do straddle the center OFDM subcarrier C have z+n intermediate OFDM subcarriers 20 therebetween. The center OFDM subcarrier C is at the center of the transmission bandwidth with no signal to be transmitted thereon. Here, n>1 and z>0.

In some embodiments, the method 100 also comprises transmitting the generated reference signal 16 within the OFDM symbol period 22, Block 120.

FIG. 6 illustrates a corresponding method 200, e.g., implemented by a wireless communication device 14, for receiving the reference signal 16. The method 200 comprises receiving, within an OFDM symbol period 22, a reference signal 16 that comprises a sequence of reference symbols distributed respectively on spaced OFDM subcarriers 18 within a transmission bandwidth such that the sequence successively repeats an integer number n of times in the time domain over the OFDM symbol period 22, Block 210. Adjacent ones of the spaced OFDM subcarriers 18 that do not straddle a center OFDM subcarrier C have z intermediate OFDM subcarriers 20 therebetween. Adjacent ones of the spaced OFDM subcarriers 18 that do straddle the center OFDM subcarrier C have z+n intermediate OFDM subcarriers 20 therebetween. The center OFDM subcarrier C is at the center of the transmission bandwidth with no signal to be transmitted thereon. And, here again, n>1 and z>0.

In some embodiments, the method 200 also comprises performing one or more measurements of the reference signal 16 received within the OFDM symbol period 22, Block 220.

Note that the radio node 12, e.g., base station, as described above may perform any of the processing herein by implementing any functional means or units. In one embodiment, for example, the radio node 12 comprises respective circuits or circuitry configured to perform the steps shown in FIG. 5. The circuits or circuitry in this regard may comprise circuits dedicated to performing certain functional processing and/or one or more microprocessors in conjunction with memory. In embodiments that employ memory, which may comprise one or several types of memory such as read-only memory, ROM, random-access memory, cache memory, flash memory devices, optical storage devices, etc., the memory stores program code that, when executed by the one or more processors, carries out the techniques described herein.

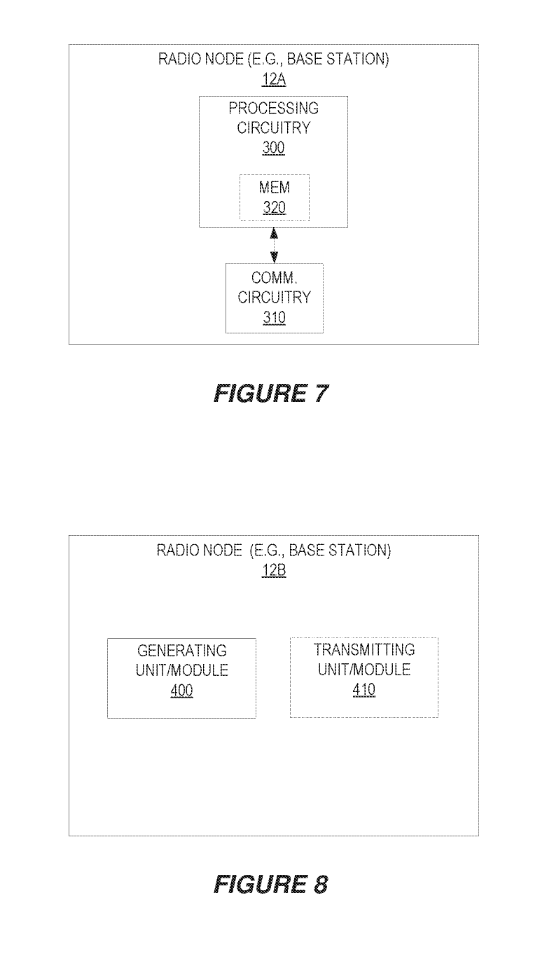

FIG. 7 illustrates a radio node 12 implemented in the form of a radio node 12A in accordance with one or more embodiments. As shown, the radio node 12A includes processing circuitry 300 and communication circuitry 310. The communication circuitry 310 is configured to transmit and/or receive information to and/or from one or more other nodes, e.g., via any communication technology. The processing circuitry 300 is configured to perform processing described above, e.g., in FIG. 5, such as by executing instructions stored in memory 320. The processing circuitry 300 in this regard may implement certain functional means, units, or modules.

FIG. 8 illustrates a radio node 12 implemented in the form of a radio node 12B in accordance with one or more other embodiments. As shown, the radio node 12B implements various functional means, units, or modules, e.g., via the processing circuitry 300 in FIG. 7 and/or via software code. These functional means, units, or modules, e.g., for implementing the method in FIG. 5, include for instance a generating unit or module 400 for generating a reference signal 16 that comprises a sequence of reference symbols distributed respectively on spaced OFDM subcarriers 18 within a transmission bandwidth such that the sequence successively repeats an integer number n of times in the time domain over an OFDM symbol period 22. Adjacent ones of the spaced OFDM subcarriers 18 that do not straddle a center OFDM subcarrier have z intermediate OFDM subcarriers 20 therebetween. Adjacent ones of the spaced OFDM subcarriers 18 that do straddle the center OFDM subcarrier have z+n intermediate OFDM subcarriers 20 therebetween. The center OFDM subcarrier is at the center of the transmission bandwidth with no signal to be transmitted thereon. Here, n>1 and z>0. In some embodiments, radio node 12B also includes a transmitting unit or module 410 for transmitting the generated reference signal 16 over the OFDM symbol period 22.

Similarly, a radio node 14, e.g., a wireless communication device, as described above may perform any of the processing herein by implementing any functional means or units. In one embodiment, for example, the radio node 14 comprises respective circuits or circuitry configured to perform the steps shown in FIG. 6. The circuits or circuitry in this regard may comprise circuits dedicated to performing certain functional processing and/or one or more microprocessors in conjunction with memory. In embodiments that employ memory, which may comprise one or several types of memory such as read-only memory, ROM, random-access memory, cache memory, flash memory devices, optical storage devices, etc., the memory stores program code that, when executed by the one or more processors, carries out the techniques described herein.

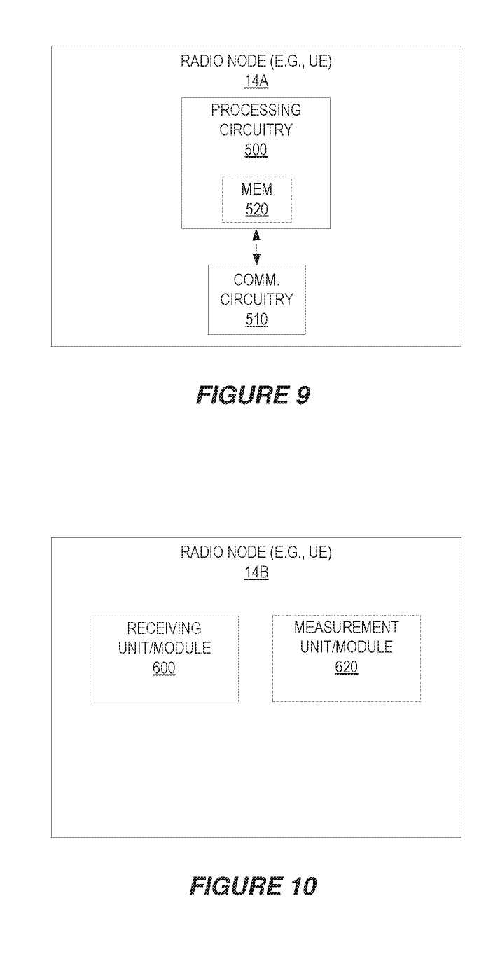

FIG. 9 illustrates a radio node 14 implemented in the form of a radio node 14A in accordance with one or more embodiments. As shown, the radio node 14A includes processing circuitry 500 and communication circuitry 510. The communication circuitry 510 is configured to transmit and/or receive information to and/or from one or more other nodes, e.g., via any communication technology. The processing circuitry 500 is configured to perform processing described above, e.g., in FIG. 6, such as by executing instructions stored in memory 520. The processing circuitry 500 in this regard may implement certain functional means, units, or modules.

FIG. 10 illustrates a radio node 14 implemented in the form of a radio node 14B in accordance with one or more other embodiments. As shown, the radio node 14B implements various functional means, units, or modules, e.g., via the processing circuitry 500 in FIG. 9 and/or via software code. These functional means, units, or modules, e.g., for implementing the method in FIG. 6, include for instance a first part receiving unit or module 600 for receiving, within an OFDM symbol period 22, a reference signal 16 that comprises a sequence of reference symbols distributed respectively on spaced OFDM subcarriers 18 within a transmission bandwidth such that the sequence successively repeats an integer number n of times in the time domain over the OFDM symbol period 22. Adjacent ones of the spaced OFDM subcarriers 18 that do not straddle a center OFDM subcarrier C have z intermediate OFDM subcarriers 20 therebetween. Adjacent ones of the spaced OFDM subcarriers 18 that do straddle the center OFDM subcarrier C have z+n intermediate OFDM subcarriers 20 therebetween. The center OFDM subcarrier C is at the center of the transmission bandwidth with no signal to be transmitted thereon. And, here again, n>1 and z>0. In some embodiments, the radio node 14 further includes a measurement module 610 for performing one or more measurements of the reference signal 16 received within the OFDM symbol period 22.

Note that in some embodiments, the sequence of reference symbols may be transmitted from different transmission points, e.g., antennas, in an orthogonal manner. The sequence transmitted by different antennas may for instance be shifted relative to one another. For example:

1^{st} antenna. S=[a000 0000 b000 0000 . . . ]

2^{nd} antenna. S=[0000 a000 0000 b000 . . . ]

Similarly, the base station 12 may not use all possible non-zero symbol values in the sequence S. For example:

S=A000 B000 C 000 D000

1^{st} antenna, set B, D=0

S=A000 0000 C 000 0000

2^{nd} antenna, set A, C=0

S=0000 B000 0 000 D000

Also note that in some sense n*m+n−1 may be viewed as equivalent to n−1. For example: n=4, a 0 0 0 b 0 0 0 c 0 0 0. If the mapping of b is skipped, it becomes a 0 0 0 0 0 0 0 c 0 0 0. This is then n*m+n−1, m=1. In one embodiment, therefore, it is seen that a repetition of a given length, n, may consist of several repetitions, m, within that span of n.

Note also that in some embodiments, the reference signal 16 is transmitted within an OFDM symbol period also with a cyclic prefix appended thereto.

While some examples herein have described a sequence of reference symbols as comprising only four symbols, those examples are non-limiting in that any number of reference symbols may be included in the sequence. Moreover, although embodiments have been described with respect to a center OFDM subcarrier, the embodiments may also extend to a non-central OFDM subcarrier.

Although some embodiments have been described in the context of future 5G systems, the embodiments are equally extendable to other types of systems. For example, the wireless communication system 10 in some embodiments is an LTE system or an evolution thereof.

Note that although embodiments above have been described with respect to a base station 12 generating and transmitting the reference signal 16, and a wireless communication device 14 receiving that reference signal 16, embodiments herein are generally applicable to any types of radio nodes.

In this regard, a radio node herein is any type of node, e.g., a base station or a wireless communication device, capable of communicating with another node over radio signals. A wireless communication device is any type device capable of communicating with another radio node over radio signals. A wireless communication device may therefore refer to a user equipment, UE, a mobile station, a laptop, a smartphone, a machine-to-machine, M2M, device, a machine-type communications, MTC, device, a narrowband Internet-of-Things, IoT, device, etc. That said, although the wireless communication device may be referred to as a UE, it should be noted that the wireless communication device does not necessarily have a “user” in the sense of an individual person owning and/or operating the device. A wireless communication device may also be referred to as a radio device, a radio communication device, a wireless terminal, or simply a terminal—unless the context indicates otherwise, the use of any of these terms is intended to include device-to-device UEs or devices, machine-type devices or devices capable of machine-to-machine communication, sensors equipped with a wireless device, wireless-enabled table computers, mobile terminals, smart phones, laptop-embedded equipped, LEE, laptop-mounted equipment, LME, USB dongles, wireless customer-premises equipment, CPE, etc. In the discussion herein, the terms machine-to-machine, M2M, device, machine-type communication, MTC, device, wireless sensor, and sensor may also be used. It should be understood that these devices may be UEs, but may be generally configured to transmit and/or receive data without direct human interaction.

In an IoT scenario, a wireless communication device as described herein may be, or may be comprised in, a machine or device that performs monitoring or measurements, and transmits the results of such monitoring measurements to another device or a network. Particular examples of such machines are power meters, industrial machinery, or home or personal appliances, e.g. refrigerators, televisions, personal wearables such as watches etc. In other scenarios, a wireless communication device as described herein may be comprised in a vehicle and may perform monitoring and/or reporting of the vehicle's operational status or other functions associated with the vehicle.

The present invention may, of course, be carried out in other ways than those specifically set forth herein without departing from essential characteristics of the invention. The present embodiments are to be considered in all respects as illustrative and not restrictive.

1-27. (canceled)

28. A method of generating a reference signal in an Orthogonal Frequency-Division Multiplexing (OFDM) system, the method comprising generating a reference signal that comprises a sequence of reference symbols distributed respectively on spaced OFDM subcarriers within a transmission bandwidth such that the sequence successively repeats an integer number n of times in the time domain over an OFDM symbol period, wherein adjacent ones of the spaced OFDM subcarriers that do not straddle a center OFDM subcarrier have z intermediate OFDM subcarriers therebetween, wherein adjacent ones of the spaced OFDM subcarriers that do straddle the center OFDM subcarrier have z+n intermediate OFDM subcarriers therebetween, wherein the center OFDM subcarrier is at the center of the transmission bandwidth with no signal to be transmitted thereon, and wherein n>1 and z>0.

29. The method of claim 28, further comprising transmitting the generated reference signal within the OFDM symbol period.

30. The method of claim 28, wherein the sequence comprises r reference symbols distributed respectively on r spaced OFDM subcarriers, and wherein
$$r \leq \frac{N}{n} ,$$
where N is a total number of subcarriers defined within the transmission bandwidth.

31. The method of claim 28, wherein z=n−1 or z=mn+n−1, where m≥0.

32. The method of claim 28, wherein said generating comprises applying the reference symbols to modulators that respectively correspond to the spaced OFDM subcarriers.

33. The method of claim 28, wherein said generating comprises constructing an overall sequence of N−1 symbols in sequence positions that respectively map to N−1 OFDM subcarriers defined within the transmission bandwidth, excluding the center OFDM subcarrier to which no sequence position is mapped, where N is a total number of subcarriers defined within the transmission bandwidth, wherein said constructing comprises constructing the overall sequence to include z+n−1 zero-valued symbols in sequence positions which map to the intermediate OFDM subcarriers between adjacent ones of the spaced OFDM subcarriers that do straddle the center OFDM subcarrier and to include z zero-valued symbols in sequence positions which map to the intermediate OFDM subcarriers between adjacent ones of the spaced OFDM subcarriers that do not straddle the center OFDM subcarrier.

34. The method of claim 33, wherein the sequence positions are indexed with an index k whose range crosses but does not include k=0.

35. The method of claim 28, wherein said generating comprises constructing an overall sequence of N−z−1 symbols in sequence positions that respectively map to N−z−1 OFDM subcarriers defined within the transmission bandwidth, wherein no sequence position maps to the center OFDM subcarrier and no sequence position maps to z OFDM subcarriers adjacent to or surrounding the center OFDM subcarrier, where N is a total number of subcarriers defined within the transmission bandwidth, wherein said constructing comprises constructing the overall sequence to include z zero-valued symbols in between each pair of adjacent reference symbols.

36. The method of claim 35, wherein the sequence positions are indexed with an index k whose range crosses but does not include k=0.

37. The method of claim 28, wherein the method is performed by a radio node, wherein the radio node is a base station.

38. A method of performing measurements on a reference signal in an Orthogonal Frequency-Division Multiplexing, OFDM, system, the method comprising:
receiving, within an OFDM symbol period, a reference signal that comprises a sequence of reference symbols distributed respectively on spaced OFDM subcarriers within a transmission bandwidth such that the sequence successively repeats an integer number n of times in the time domain over an OFDM symbol period, wherein adjacent ones of the spaced OFDM subcarriers that do not straddle a center OFDM subcarrier have z intermediate OFDM subcarriers therebetween, wherein adjacent ones of the spaced OFDM subcarriers that do straddle the center OFDM subcarrier have z+n intermediate OFDM subcarriers therebetween, wherein the center OFDM subcarrier is at the center of the transmission bandwidth with no signal to be transmitted thereon, and wherein n>1 and z>0; and
performing one or more measurements of the reference signal received within the OFDM symbol period.

39. The method of claim 38, wherein the sequence comprises r reference symbols distributed respectively on r spaced OFDM subcarriers, and wherein
$$r \leq \frac{N}{n} ,$$
where N is a total number of subcarriers defined within the transmission bandwidth.

40. The method of claim 38, wherein z=n−1 or z=mn+n−1, where m≥0.

41. The method of claim 38, wherein the method is performed by a radio node, wherein the radio node is a user equipment.

42. A radio node configured to generate a reference signal in an Orthogonal Frequency-Division Multiplexing, OFDM, system, the radio node comprising processing circuitry and a memory, the memory containing instructions executable by the processing circuitry whereby the radio node is configured to generate a reference signal that comprises a sequence of reference symbols distributed respectively on spaced OFDM subcarriers within a transmission bandwidth such that the sequence successively repeats an integer number n of times in the time domain over an OFDM symbol period, wherein adjacent ones of the spaced OFDM subcarriers that do not straddle a center OFDM subcarrier have z intermediate OFDM subcarriers therebetween, wherein adjacent ones of the spaced OFDM subcarriers that do straddle the center OFDM subcarrier have z+n intermediate OFDM subcarriers therebetween, wherein the center OFDM subcarrier is at the center of the transmission bandwidth with no signal to be transmitted thereon, and wherein n>1 and z>0.

43. The radio node of claim 42, wherein the memory contains instructions executable by the processing circuitry whereby the radio node is configured to transmit the generated reference signal within the OFDM symbol period.

44. The radio node of claim 42, wherein the sequence comprises r reference symbols distributed respectively on r spaced OFDM subcarriers, and wherein
$$r \leq \frac{N}{n} ,$$
where N is a total number of subcarriers defined within the transmission bandwidth.

45. The radio node of claim 42, rein z=n−1 or z=mn+n−1, where m≥0.

46. The radio node of claim 42, wherein the memory contains instructions executable by the processing circuitry whereby the radio node is configured to generate the reference signal by applying the reference symbols to modulators that respectively correspond to the spaced OFDM subcarriers.

47. The radio node of claim 42, wherein the memory contains instructions executable by the processing circuitry whereby the radio node is configured to generate the reference signal by constructing an overall sequence of N−1 symbols in sequence positions that respectively map to N−1 OFDM subcarriers defined within the transmission bandwidth, excluding the center OFDM subcarrier to which no sequence position is mapped, where N is a total number of subcarriers defined within the transmission bandwidth, wherein said constructing comprises constructing the overall sequence to include z+n−1 zero-valued symbols in sequence positions which map to the intermediate OFDM subcarriers between adjacent ones of the spaced OFDM subcarriers that do straddle the center OFDM subcarrier and to include z zero-valued symbols in sequence positions which map to the intermediate OFDM subcarriers between adjacent ones of the spaced OFDM subcarriers that do not straddle the center OFDM subcarrier.

48. The radio node of claim 47, wherein the sequence positions are indexed with an index k whose range crosses but does not include k=0.

49. The radio node of claim 42, wherein the memory contains instructions executable by the processing circuitry whereby the radio node is configured to generate the reference signal by constructing an overall sequence of N−z−1 symbols in sequence positions that respectively map to N−z−1 OFDM subcarriers defined within the transmission bandwidth, wherein no sequence position maps to the center OFDM subcarrier and no sequence position maps to z OFDM subcarriers adjacent to or surrounding the center OFDM subcarrier, where N is a total number of subcarriers defined within the transmission bandwidth, wherein said constructing comprises constructing the overall sequence to include z zero-valued symbols in between each pair of adjacent reference symbols.

50. The radio node of claim 49, wherein the sequence positions are indexed with an index k whose range crosses but does not include k=0.

51. The radio node of claim 42, wherein the radio node is a base station.

52. A radio node configured to perform measurements on a reference signal in an Orthogonal Frequency-Division Multiplexing, OFDM, system, the radio node comprising:
processing circuitry and a memory, the memory containing instructions executable by the processing circuitry whereby the radio node is configured to:
receive, within an OFDM symbol period, a reference signal that comprises a sequence of reference symbols distributed respectively on spaced OFDM subcarriers within a transmission bandwidth such that the sequence successively repeats an integer number n of times in the time domain over an OFDM symbol period, wherein adjacent ones of the spaced OFDM subcarriers that do not straddle a center OFDM subcarrier have z intermediate OFDM subcarriers therebetween, wherein adjacent ones of the spaced OFDM subcarriers that do straddle the center OFDM subcarrier have z+n intermediate OFDM subcarriers therebetween, wherein the center OFDM subcarrier is at the center of the transmission bandwidth with no signal to be transmitted thereon, and wherein n>1 and z>0; and
perform one or more measurements of the reference signal received within the OFDM symbol period.

53. The radio node of claim 52, wherein the sequence comprises r reference symbols distributed respectively on r spaced OFDM subcarriers, and wherein
$$r \leq \frac{N}{n} ,$$
where N is a total number of subcarriers defined within the transmission bandwidth.

54. The radio node of claim 52, wherein z=n−1 or z=mn+n−1, where m≥0.

55. The radio node of claim 52, wherein the radio node is a user equipment.
